(19) United States
(12) Patent Application Publication
(10) Pub. No.: US 2007/0005549 A1
(43) Pub. Date: Jan. 4, 2007

(54) Document information extraction with cascaded hybrid model

(75) Inventors: Ming Zhou, Beijing (CN); Kun Yu, Hefei (CN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/149,713

(22) Filed: Jun. 10, 2005

(51) Int. Cl. G06F 17/30

(52) U.S. Cl. 707/1

(57) ABSTRACT

General information blocks of text are extracted from a document. A label is applied to each general information block and detailed information strings of text are extracted from at least one of the general information blocks based on the corresponding label of the at least one general information block.

### BACKGROUND

The discussion below is merely provided for general background information and is not intended to be used as an aid in determining the scope of the claimed subject matter.

Resumes from job applicants arrive in large volumes at potential employers. In large organizations, hundreds of resumes from job applicants can be received in a single week. The resumes can be of different formats, including different file types, different structures and different styles. Additionally, resumes can be written in different languages. Moreover, employers may receive resumes at a central location for a variety of different jobs. For example, a central location may receive resumes for both engineering jobs and sales jobs. The large volume of information from these resumes makes it difficult to organize and filter the resumes in order to find qualified candidates for open positions. As a result, a process for information extraction to manage resumes would be beneficial.

### SUMMARY

This Summary is provided to introduce some concepts in a simplified form that are further described below in the Detailed Description. This Summary is not intended to identify key features or essential features of the claimed subject matter, nor is it intended to be used as an aid in determining the scope of the claimed subject matter.

In one aspect of the subject matter described below, general information blocks of text are extracted from a document. A label is applied to each general information block and detailed information strings of text are extracted from at least one of the general information blocks based on the corresponding label of the at least one general information block.

In another aspect, a first type of information is extracted from the document using a first extraction model. A second type of information is extracted from the document using a second extraction model that is different from the first extraction model.

In yet another aspect, a resume is segmented into blocks of text. Additionally, a personal information block and an education information block are identified from the blocks of text and labels are applied thereto. Labels are applied to information within the personal information block and the education information block.

### BRIEF DESCRIPTION OF THE DRAWINGS

FIG. 1 is a block diagram of a general computing environment.

FIG. 2 is a flow diagram of applicant information.

FIG. 3 is a block diagram of a structure of a hierarchy of information in a document.

FIG. 4 is a block diagram of a structure of a hierarchy of specific information fields of a resume.

FIG. 5 is a block diagram of a model used for information extraction from a document.

FIG. 6 is an example resume segmented into blocks and tagged information fields extracted from the resume.

### DETAILED DESCRIPTION

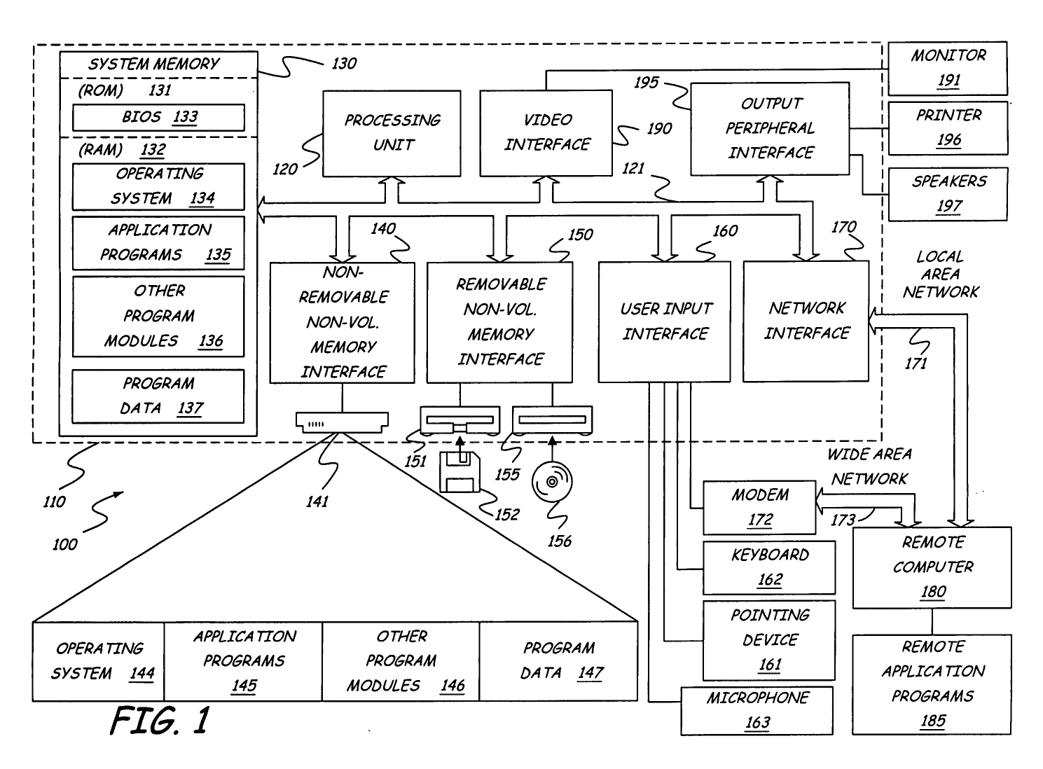

Before describing methods and systems for automatically processing applicant information, a general computing environment in which the present invention can be embodied will be described. FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. Tasks performed by the programs and modules are described below and with the aid of figures. Those skilled in the art can implement the description and figures as processor executable instructions, which can be written on any form of a computer readable medium.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available medium or media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

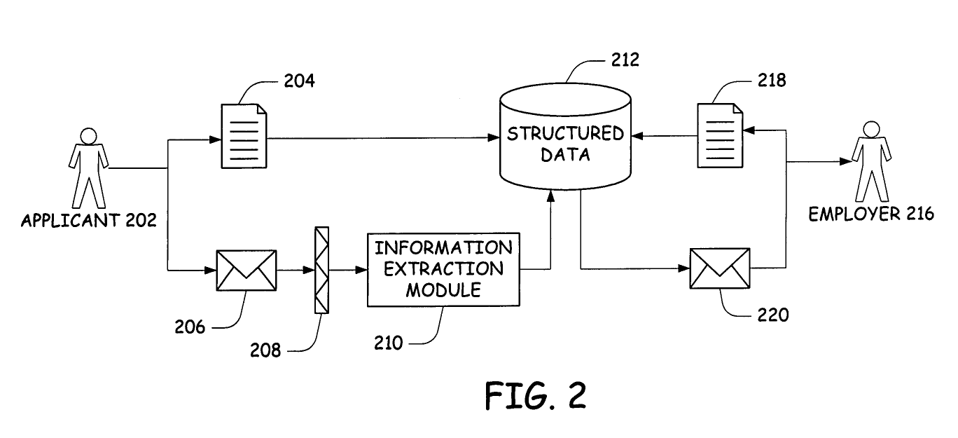

FIG. 2 is a flow diagram 200 for handling applicant information. An applicant 202 provides information through a form 204 and/or an email message 206. Form 204 can be an online form in which applicant 202 fills in information, for example information related to prior education, work experience, interests, etc. Email message 206 can include an attached document having a resume of applicant 202. If desired, a filter 208 can be used to filter unwanted email messages and/or attachments to email messages. Job application email messages that pass through filter 208 are routed to information extraction module 210. As discussed in further detail below, information from resumes are extracted and provided to a database 212. Information within form 204 is also provided to database 212.

An employer 216 can issue a query 218 to database 212 in order to find candidates for a particular job. Query 218 can contain specified information regarding job requirements. Data associated with an applicant 202 can be routed using an email message 220 (or other mode of communication) to employer 216. If desired, applicant information can be automatically routed to employer 216 based on desired applicant qualifications. For example, employer 216 can be sent resumes automatically for candidates having a PhD in computer science.

Although resumes can be of different formats and languages, the information contained therein includes several identifiable fields that can be viewed as particular information elements or types. Information corresponding to these elements can be extracted from resumes to easily manage applicant information. To perform extraction, resume information can be represented as a hierarchical structure.

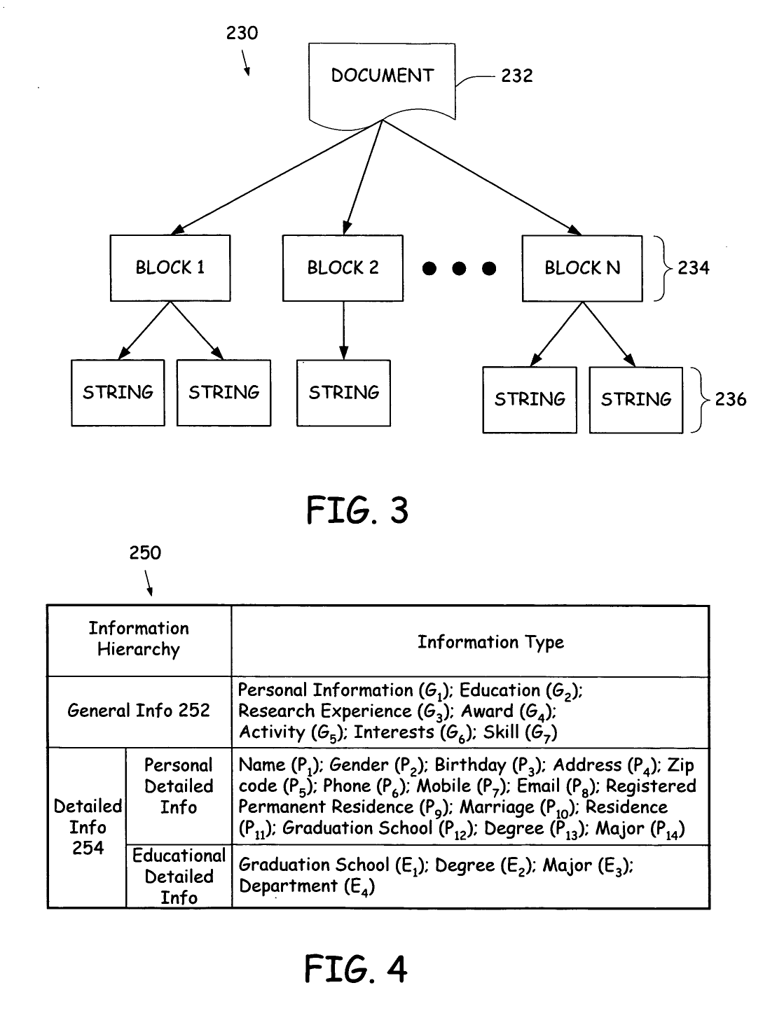

FIG. 3 illustrates a hierarchical structure 230 utilized by information extraction module 210. Structure 230 includes a document 232 that contains information for extraction. Structure 230 represents a hierarchy for which information from document 232 is extracted. A general level 234 includes a number of different blocks, herein illustrated as block 1-block N. Blocks 1-N contain general information blocks within document 232. Blocks 1-N can be extracted using an extraction model or algorithm. Structure 230 also includes a detailed level 236. Detailed level 236 includes a number of strings associated with blocks in general level 234. Each block in level 234 has one or more associated strings that are extracted using a specified extraction model. In one aspect of the present invention, a particular extraction model is selected based on a particular block.

FIG. 4 is a structure 250 that includes specific informational elements for information extraction from resumes. General information level 252 includes blocks related to personal information, education, research, experience, etc. In this example, seven general information fields are defined in level 252. More detailed information can be extracted from the blocks in general information level 252. This information is included in a detailed information level 254. For example, personal detailed information can include a name, address, zip code, phone number, etc. Furthermore, educational detailed information block can include a graduation school, a degree, a major and a department. In structure 250, fourteen personal information fields are defined and four education information fields are defined in level 254.

In an embodiment of the present invention, a cascaded hybrid framework is used to explore the hierarchical contextual structure 250 of resumes. Given the hierarchy of resume information, a cascaded two-pass information extraction framework is designed. In a first pass, general information (for example for general information level 252) is extracted by segmenting a resume into consecutive blocks wherein each block is annotated with a label indicating a corresponding field. In a second pass, detailed information (for example for detailed information level 254) is further extracted within the boundary of specified blocks.

This approach can speed up extraction and improve precision of extracting information pieces significantly. Moreover, for different types of information, separate extraction methods can be selected to provide an effective information extraction process. In one embodiment, since there exists a strong sequence among blocks, a hidden markov model (HMM) is selected to segment a resume and label each block with a field of general information. An HMM is also used for educational information extraction for the same reason. A classification based method is selected for personal information extraction, where information elements tend to appear independently.

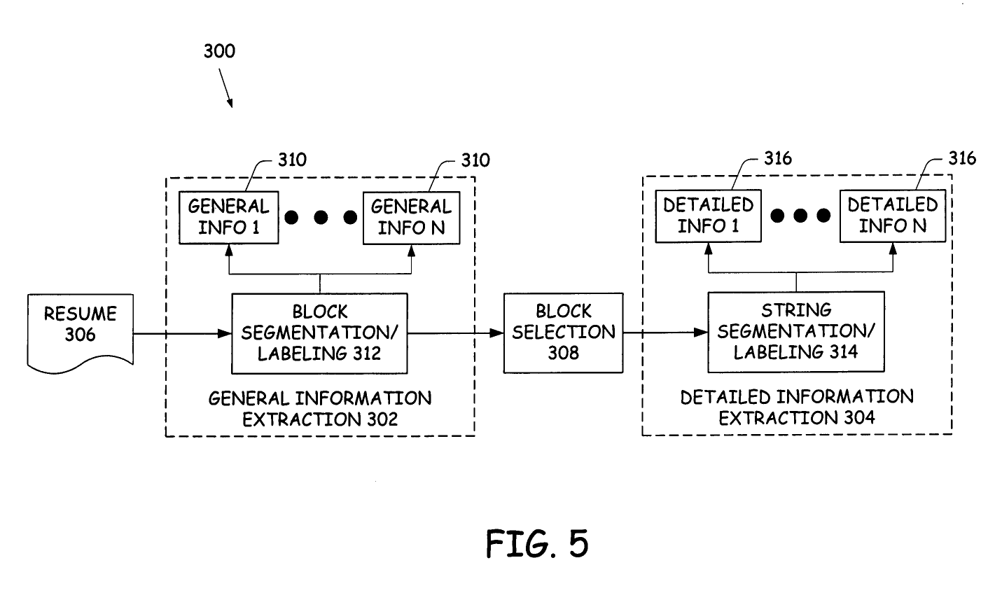

FIG. 5 is a block diagram of a cascaded hybrid model 300 according to an embodiment of the present invention. Model 300 includes a general information extraction module 302 and a detailed information extraction module 304. General information extraction module 302 segments a resume 306 into consecutive blocks using an HMM model. Then, based on the result, detailed information extraction module 304 uses an HMM to extract educational information and a classification method (for example Support Vector Machines (SVM)) to extract personal information. Block selection module 308 is used to decide a range of information extraction (for example where to begin extraction and where to end extraction) for detailed information extraction module 304.

For general information extraction module 302, the information extraction process labels segmented units of resume 306 with predefined labels as presented in structure 250 of FIG. 4. Given an input resume T, which is a sequence of words, w₁, w₂, . . . , wₖ, general information extraction module 302 outputs a sequence of blocks 310 in which some words are grouped into a certain block, T=t₁, t₂, . . . , tₙ, where tᵢ is a block, using block segmentation/labelling module 312. If an expected label sequence of T is L=l₁, l₂, . . . , lₙ, with each block being assigned a label lᵢ, a sequence of block and label pairs can be expressed as Q=(t₁, l₁), (t₂, l₂), . . . , (tₙ, lₙ).

Structure 250 of FIG. 4 represents a list of information fields to be extracted, where general information is represented as fields G₁˜G₇. For each field of general information, say Gᵢ, two labels are set: Gᵢ-B means a left beginning of Gᵢ, Gᵢ-M means the remainder part of Gᵢ. In addition, a label O is defined to represent a block that does not belong to any general information types. With these positional information labels, general information can be obtained. For instance, if the label sequence Q for a resume with 10 paragraphs is Q=(t₁, G₁-B), (t₂, G₁-M) (t₃, G₂-B), (t₄, G₂-M), (t₅, G₂-M), (t₆, O), (t₇, O), (t₈, G₃-B), (t₉, G₃-M), (t₁₀, G₃-M), three types of general information can be extracted as follows: G₁:[t₁, t₂], G₂:[t₃, t₄, t₅], G₃: [t₈, t₉, t₁₀].

Thus, general information extraction module 302, given a resume T=t₁, t₂, . . . , tₙ, seeks a label sequence L*=l₁, l₂, . . . , lₙ, such that a probability of the label sequence is maximal. This maximization can be represented as:

$${L}^{*} = {arg max}_{L} P ( L \vert T ) \qquad ( 1 )$$

According to Bayes' equation, equation (1) can be represented as:

$${L}^{*} = {arg max}_{L} P ( T \vert L ) \times P ( L ) \qquad ( 2 )$$

Assuming independent occurrence of blocks labelled as the same information types, P(T|L) can be expressed as:

$$P ( T \text{\vert} L ) = {\prod }_{i = 1}^{n} P ( {t}_{i} \text{\vert} {l}_{i} ) \qquad ( 3 )$$

Here P(tᵢ|lᵢ) is called an emission probability. To calculate P(tᵢ|lᵢ), independence of words occurring in tᵢ can be assumed and then probabilities of these words can be multiplied together to get the probability of tᵢ. Thus, P(tᵢ|lᵢ) can be expressed as:

$$P ( {t}_{i} \text{\vert} {l}_{i} ) = {\prod }_{r = 1}^{m} P ( {w}_{r} \text{\vert} {l}_{i} ) , where {t}_{i} = \{ {w}_{1} , {w}_{2} , … {w}_{m} \} \qquad ( 4 )$$

If a tri-gram model is used to estimate P(L), P(L) can be expressed as:

$$P ( L ) = P ( {l}_{1} ) ⨯ P ( {l}_{2} \text{\vert} {l}_{1} ) {\prod }_{i = 3}^{n} P ( {l}_{i} \text{\vert} {l}_{i - 1} , {l}_{i - 2} ) \qquad ( 5 )$$

Here, P(lᵢ|lᵢ₋₁, lᵢ₋₂) and P(lᵢ|lᵢ₋₁) are called transition probabilities.

Both words and named entities are used as features in the HMM for general information extraction module 302. If a character based language (i.e. Chinese, Japanese, Korean, etc.) is used for a resume C=c₁′, c₂′, . . . , cₖ′, the resume is first tokenized into C=w₁, w₂, . . . , wₖ with a word segmentation system. Such a system can output words and named entities. In one example, 8 types of named identities are identified (Name, Date, Location, Organization, Phone, Number, Period, and Email). The named entities of the same type are normalized into a single identification in a feature set.

In the HMM, a connected structure with one state representing one information label can be applied due to convenience. To estimate the transition probability and the emission probability, maximum likelihood estimation is used, which can be expressed as:

$$\begin{matrix}P ( {l}_{i} \text{\vert} {l}_{i - 1} , {l}_{i - 2} ) = \frac{count ( {l}_{i} , {l}_{i - 1} , {l}_{i - 2} )}{count ( {l}_{i - 1} , {l}_{i - 2} )} & ( 6 ) \\ P ( {l}_{i} \text{\vert} {l}_{i - 1} ) = \frac{count ( {l}_{i} , {l}_{i - 1} )}{count ( {l}_{i - 1} )} & ( 7 ) \\ P ( {w}_{r} \text{\vert} {l}_{i} ) = \frac{count ( {w}_{r} , {l}_{i} )}{{\sum }_{r = 1}^{m} count ( {w}_{r} , {l}_{i} )} & ( 8 )\end{matrix}$$

Where state i contains m distinct words. Smoothing can be applied if desired. For a word wᵣ seen in training data, the emission probability is P(wᵣ|lᵢ)×(1−x), where P(wᵣ|lᵢ) is the emission probability calculated with equation 8 and x=Eᵢ/Sᵢ (Eᵢ is the number of words appearing only once in state i and Sᵢ is the total number of words occurring in state i). For an unseen word wᵣ, the emission probability is x/(M−mᵢ), where M is the number of all the words appearing in training data, and mᵢ is the number of distinct words occurring in state i.

Block selection module 308 is used to select blocks generated from generated information extraction module 302 as input for detailed information extraction module 304. Mistakes of general information extraction can occur from labelling non-boundary blocks as boundaries in general information extraction module 302. Thus, a fuzzy block selection strategy can be employed, which selects blocks labelled with target general information and also selects surrounding blocks, so as to enlarge the extracting range for detailed information extraction module 304. String segmentation/labelling module 314 extracts detailed information blocks 316 depending on labels of blocks 310.

To extract educational detailed information from an education general information block, string segmentation module 314 uses an HMM. The HMM expresses a text T as a word sequence T=w₁, w₂, . . . , wₙ, and uses two labels Dᵢ-B and Dᵢ-M to represent the beginning and remaining part of Dᵢ, respectively. In addition, a label O is used to represent that the corresponding word does not belong to any kind of educational detailed information.

In this model, a probability P(L) can be calculated using equation 5, which is the same as the previous model discussed above. Since the segmentation is based on words in this HMM, the probability P(T|L) is calculated by:

$$P ( T \text{\vert} L ) = {\prod }_{i = 1}^{n} P ( {w}_{i} \text{\vert} {l}_{i} ) \qquad ( 9 )$$

Here, independent occurrence of words labelled as the same information types is assumed.

Personal detailed information extraction is performed using a classification algorithm. In one embodiment, an SVM is selected for robustness to over-fitting, efficiency and high performance. In the SVM model, string segmentation/labelling module 314 labels segmented units with predefined labels, for example those in FIG. 4. After expressing a text T as a word sequence T=w₁, w₂, . . . , wₖ, personal detailed information extraction is a sequence of units, in which some words are grouped into units, T=t₁, t₂, . . . , tₙ where tᵢ is a unit. A label sequence can be expressed as L=l₁, l₂, . . . , lₙ. Thus, a sequence of unit and label pairs is expressed as Q=(t₁, l₁), (t₂, l₂), . . . , (tₙ, lₙ), where each unit tᵢ is associated with lᵢ, with respect to personal detailed information.

For personal detailed information listed in FIG. 4, say Pᵢ, two labels are defined: Pᵢ-B representing its left beginning, and Pᵢ-M representing the remainder part. Furthermore, O means that the corresponding unit does not belong to any personal detailed information boundaries and information fields. For example, for part of a resume “Name:Alice (Female)”, there are three units after segmentation with punctuations, i.e. “Name”, “Alice”, “Female”. After applying SVM classification, we can get the label sequence as P₁-B, P₁-M, P₂-B. With this sequence of unit and label pairs, two types of personal detailed information can be extracted as P₁: [Name:Alice] and P₂: [Female].

Various ways can be applied to segment a resume T. In one embodiment, segmentation is based on a natural sentence of T. This segmentation is based on an observation that detailed information is usually separated by punctuations (e.g. comma, Tab tag or Enter tag).

The extraction of personal detailed information can be expressed as follows: given a text T=t₁, t₂, . . . , tₙ, where tᵢ is a unit defined by the segmenting method mentioned above, string segmentation/labelling module 314 seeks a label sequence L*=l₁, l₂, . . . , lₙ, such that the probability of the sequence of labels is maximal.

$${L}^{*} = {arg max}_{L} P ( L \vert T ) \qquad ( 10 )$$

The independence of label assignment between units can be assumed. With this assumption, equation 10 can be expressed as:

$${L}^{*} = {arg max}_{L = {l}_{1} , {l}_{2} … {l}_{n}} {\prod }_{i = 1}^{n} P ( {l}_{i} \text{\vert} {t}_{i} ) \qquad ( 11 )$$

Thus, this probability can be maximized by maximizing each term in turn.

Features defined in the SVM model can be described as follows:

Word: Words that occur in a unit. Each word appearing in a dictionary is a feature. TF*IDF can be a feature weight, where TF means word frequency in the text, and IDF can be expressed as:

$$IDF ( w ) = {Log}_{2} \frac{N}{{N}_{w}} \qquad ( 12 )$$

N: the total number of training examples;
N_{w}: the total number of positive examples that contain word w

Named Entity: Named entities that appear in a unit. Similar to the above HMM models, 8 types of named entities can be used, i.e., Name, Date, Location, Organization, Phone, Number, Period, Email, are selected as binary features. If any one type of them appears in the text, then the weight of this feature is 1, otherwise the weight is 0.

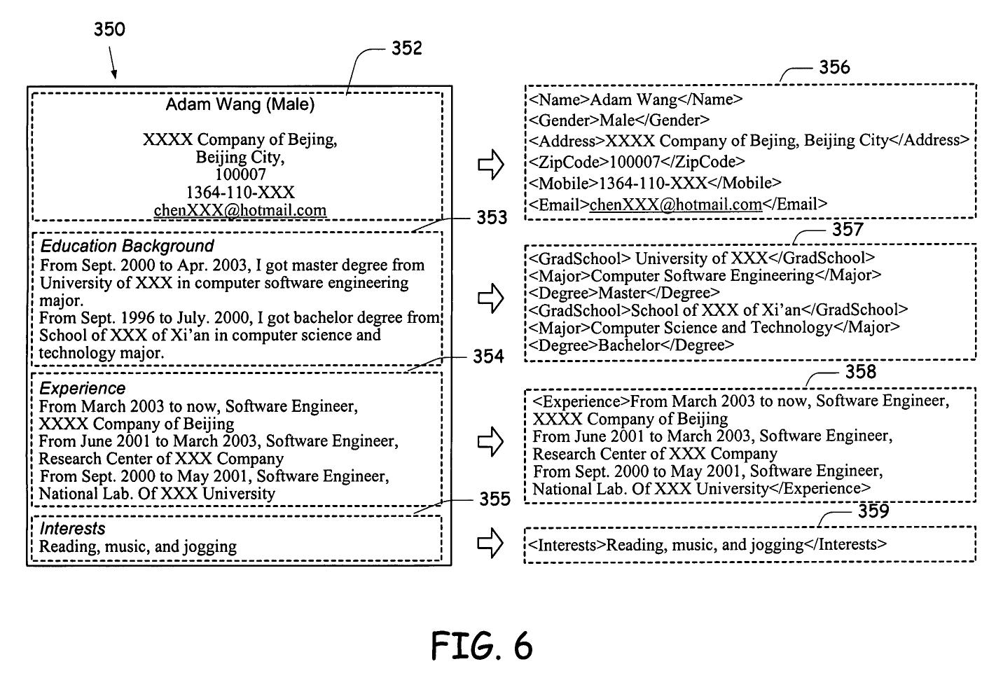

With further reference to FIG. 6, an exemplary resume 350 is illustrated. Block segmentation/labelling module 312 extracts general information blocks 352-355. Block 352 is labelled a personal information block, block 353 is labelled an education information block, block 354 is labelled an experience information block and block 355 is labelled an interest information block. Depending on the labels for blocks 352-355, string segmentation/labelling module 314 extracts information from blocks 352-355 and labels information contained therein. Tagged information blocks 356-359 correspond to blocks 352-355, respectively. Block 356 includes tags for detailed personal information within block 352, for example, name, gender, address, etc. Block 357 includes tagged information for detailed education information from block 353. Blocks 358 and 359 include the tags <Experience> and <Interests>, respectively.

A multitude of formats and complicated attributes of resumes make it difficult to extract information accurately from resumes. A cascaded hybrid information extraction model, which explores the document-level hierarchical contextual structure of resumes, is presented to handle this problem. This model not only applies a cascaded framework to extract general information and detailed information from a resume hierarchically, but also uses different techniques to extract information in different layers based on their characteristics. In a first pass, general information is extracted by an HMM. Then, different information extraction models are applied to extract detailed information from different kinds of general information obtained from a first pass. By exploring the hierarchical contextual structure of resumes, this cascaded hybrid strategy effectively improves information extraction from resumes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of processing information in a document, comprising:
extracting general information blocks of text from the document;
applying a label to each general information block; and
extracting detailed information strings of text from at least one of the general information blocks based on the corresponding label of the at least one general information block.

2. The method of claim 1 and further comprising applying a label to the detailed information strings.

3. The method of claim 1 wherein the general information blocks are extracted using a first extraction model and at least one of the detailed information strings is extracted using a second extraction model, different from the first extraction model.

4. The method of claim 3 wherein the first extraction model is a hidden markov model and the second extraction model is a support vector machine.

5. The method of claim 1 wherein the document is a resume.

6. The method of claim 5 wherein one general information block includes a personal information label and one general information block includes an education information label.

7. The method of claim 6 wherein detailed information strings are extracted from the personal information block and include information related to at least one of a name, address, zip code, phone number and email address.

8. The method of claim 6 wherein detailed information strings are extracted from the education information block and include information related to at least one of a school, a degree, a major and a department.

9. A computer implemented method of extracting information from a document, comprising:
extracting a first type of information from the document using a first extraction model; and
extracting a second type of information from the document using a second extraction model that is different than the first extraction model.

10. The method of claim 9 wherein the first extraction model is a hidden markov model and the second extraction model is a classification model.

11. The method of claim 9 wherein the first type of information is related to personal information and the second type of information is related to education information.

12. The method of claim 9 and further comprising:
applying labels to portions of information of the first information type based on the first extraction model; and
applying labels to portions of information of the second information type based on the second extraction model.

13. A computer implemented method for processing a resume, comprising:
segmenting the resume into blocks of text;
identifying a personal information block from the blocks of text and applying a label thereto;
identifying an education information block from the blocks of text and applying a label thereto;
applying personal information labels to portions of text in the personal information block by classifying the portions based on a set of fields relating to personal information; and
identifying a sequence of words in the education information block and applying education information to the words based on the sequence.

14. The method of claim 13 and further comprising:
identifying an experience information block from the blocks of text and applying a label thereto.

15. The method of claim 13 and further comprising:
identifying an interests information block from the blocks of text and applying a label thereto.

16. The method of claim 13 and further comprising:
identifying at least one of an award information block, an activity information block and a skill information block and applying a label thereto.

17. The method of claim 13 and further comprising:
routing the resume to a destination based on text associated with at least one of the personal information labels and the education information labels.

18. The method of claim 13 wherein the personal information labels include at least one of a name, a gender, a birthday, an address, a zip code, a phone number, a marital status, a residence, a school, a degree and a major.

19. The method of claim 13 wherein the education information labels include at least one of a school, a degree, a major and a department.

20. The method of claim 13 wherein the resume includes at least one of Chinese text, Japanese text and Korean text and wherein segmenting the resume includes identifying words in the text.
